(19) United States
(12) Patent Application Publication
(10) Pub. No.: US 2007/0257934 A1
(43) Pub. Date: Nov. 8, 2007

(54) SYSTEM AND METHOD FOR EFFICIENT ENHANCEMENT TO ENABLE COMPUTER VISION ON MOBILE DEVICES

(76) Inventors: David Doermann, Ellicott City, MD (US); Huiping Li, Clarksville, MD (US)

Correspondence Address: 24IP LAW GROUP USA, PLLC, 12 E. LAKE DRIVE, ANNAPOLIS, MD, 21403, US

(21) Appl. No.: 11/746,044

(22) Filed: May 8, 2007

Related U.S. Application Data
(60) Provisional application No. 60/806,081, filed on Jun. 28, 2006.
(60) Provisional application No. 60/746,752, filed on May 8, 2006.
(60) Provisional application No. 60/746,755, filed on May 8, 2006.
(60) Provisional application No. 60/806,083, filed on Jun. 28, 2006.

(51) Int. Cl. G09G 5/00

(52) U.S. Cl. 345/606

(57) ABSTRACT

A system and method for using camera enabled personal digital assistant (PDA) or cell phone hardware to provide enhanced imaging capabilities. The system and method enhances images taken on a mobile camera device to enable the mobile device, for example, a personal digital assistant (PDA) or cell phone, to provide enhanced imaging capabilities. A method comprising the steps of pre-calculating a pixel value at each point on a grid and storing said pre-calculated pixel values in a lookup table, using one bit to represent each pixel in said image, quantizing said image at a small step interval such that each pixel in the image corresponds to one point on said grid, and interpolating said image through a memory-indexing process. The method may further comprise the step of performing clustering based contrast enhancement on said image prior to said step of using one bit to represent each pixel in said image.

### CROSS-REFERENCE TO RELATED APPLICATIONS

The present invention claims the benefit of the filing dates of the following U.S. Provisional Patent Applications: Ser. No. 60/806,081, entitled “Mobile Image Enhancement” and filed on Jun. 28, 2006 by David Doermann and Huiping Li; Ser. No. 60/746,752, entitled “Business Card Reader” and filed on May 8, 2006 by David Doermann and Huiping Li; Ser. No. 60/746,755, entitled “Medication Reminder” and filed on May 8, 2006 by David Doermann and Huiping Li; and Ser. No. 60/806,083, entitled “Symbol Acquisition and Recognition” and filed on Jun. 28, 2006 by David Doermann and Huiping Li.

These prior applications are hereby incorporated by reference in their entirety.

### STATEMENT REGARDING FEDERALLY SPONSORED RESEARCH OR DEVELOPMENT

None.

### BACKGROUND OF THE INVENTION

1. Field Of The Invention

The present invention relates to systems and methods for enhancement and usage of enhanced images captured using mobile devices.

2. Brief Description Of The Related Art

Previously, systems and methods have been developed for image superresolution and for text detection and tracking in digital video. See, for example, Changjiang Yang, Ramani Duraiswami, and Larry Davis, “Superresolution Using Preconditioned Conjugate Gradient Method,” University of Maryland, Computer Vision Laboratory; and Huiping Li, David Doermann, and Omid Kia, “Automatic Text Detection and tracking in Digital Video,” IEEE Transactions on Image Processing, Vol. 9, No. 1, January 2000. In recent years, it has become commonplace for mobile devices such a cell phones, personal digital assistants (PDA's) and mobile computers to have integrated cameras. Such cameras are commonly used for taking pictures and videos, but have not been further developed for use in various applications.

Traditional image processing and computer vision algorithms designed for desktop or laptop computers often assume sufficient memory, processor speed, image quality and battery power. Mobile devices, however, typically are resource limited and cannot be viewed as traditional computers. The cameras on such mobile devices typically are low resolution CMOS technology; processors are an order of magnitude slower than typical desktop or laptop computers and may not have floating point capability; and memory in the mobile devices typically is limited in how it can be used and is much slower than desktop or laptop memory. For these reasons, any algorithms that we have must be implemented carefully and efficiently to ensure that the performance requirements can be met for new applications.

### SUMMARY OF THE INVENTION

The present invention is a system and method for enhancing images taken on a mobile camera device to enable the mobile device, for example, a personal digital assistant (PDA) or cell phone, to provide enhanced imaging capabilities.

In a preferred embodiment, the present invention is a method for enhancing an image on a mobile device. The method comprises the steps of pre-calculating a pixel value at each point on a grid and storing the pre-calculated pixel values in a lookup table, using one bit to represent each pixel in the image, quantizing the image at a small step interval such that each pixel in the image corresponds to one point on the grid, and interpolating the image through a memory-indexing process. The method may further comprise the step of performing clustering based contrast enhancement on the image prior to the step of using one bit to represent each pixel in the image.

In another preferred embodiment, the present invention is a system for enhancing an image on a mobile device. The system comprises means for pre-calculating a pixel value at each point on a grid, means for storing the pre-calculated pixel values in a lookup table, means for using one bit to represent each pixel in the image, means for quantizing the image at a small step interval such that each pixel in the image corresponds to one point on the grid, and means for interpolating the image through a memory-indexing process. The system may further comprise means for performing clustering based contrast enhancement on the image.

In another embodiment, the present invention is a method for enhancing an image on a mobile device, wherein coordinates of four corners (P₁, P₂, P₃ and P₄) of a bounding box in the image are known, top and bottom boundaries of the bounding box intersect at a vanishing point A and right and left boundaries of the bounding box intersect at a vanishing point B. The method comprises the steps of calculating a mapping between an ideal, non-perspective image and the image and for any matrix entry (i, j) in a w x h matrix compute its affine coordinate i/wP′₁P′₄+i/hP′₁P′₂ and use H⁻¹ to map this affine coordinate to the image coordinate. The calculated mapping comprises a plane-to-plane homograph matrix H=(H₁, H₂, H₃), wherein the step of calculating a mapping comprises the steps of reshaping matrix H as a vector h=(h₁₁, h₁₂, h₁₃, h₂₂, h₂₃, h₂₄, h₃₁, h₃₂, h₃₃)^{T}, calculating H₃ according to the equation

$$\{ \frac{{H}_{3} \cdot A = 0}{{H}_{3} \cdot B = 0} ⇒ {H}_{3} ∼ A \times B ,$$

and H₃˜((P₁×P₂)×(P₂×P₃))×((P₁×P₂)×(P₃×P₄)), calculating H according to the equation

$$H = ( \begin{matrix}{h}_{33} & 0 & 0 \\ 0 & {h}_{33} & 0 \\ {h}_{31} & {h}_{32} & {h}_{33}\end{matrix} ) ,$$

calculating H⁻¹ according to the equation

$${H}^{- 1} ∼ ( \begin{matrix}{h}_{33} & 0 & 0 \\ 0 & {h}_{33} & 0 \\ - {h}_{31} & - {h}_{32} & {h}_{33}\end{matrix} ) ,$$

and mapping P₁, P₂, P₃ and P₄ to affine points P′₁, P′₂, P′₃, P′₄ using homography H.

In another embodiment, the present invention is a method for enhancing an image on a mobile device. The method comprises the steps of, for each pixel in the image, determining if binarization is required based upon an N×N neighborhood using a block-based approach. If binarization is not necessary for a particular neighborhood, set all pixels in the particular neighborhood to background. For each pixel requiring binarization, calculating a binarization threshold using Nibliack's approach and conducting binarization, and post-processing the binary image to remove ghost objects.

In still another embodiment of the present invention, the present invention is a method for enhancing an image on a mobile device comprising the steps of representing each foreground pixel in the image with a pattern vector generated from pixel values in an N×N neighborhood of the foreground pixel and converting each foreground pixel to f² pixels in a higher resolution image where f is a magnification factor. How to convert a foreground pixel depends upon the pattern vector, k-1 other pattern vectors in the image that are similar to the pattern vector where similarity is measured by a Hamming distance of two pattern vectors, and pixels in the higher resolution image corresponding to the k pattern vectors.

In still other embodiments, the present invention is an application incorporating some or all of the image enhancement methods and systems. In one such embodiment, the present invention is a medication reminder system on a mobile device. The system comprises a means such as a camera for acquiring digital images of barcodes, means for enhancing acquired digital images, means for enrolling medication in the system using the digital images, means for scheduling medication intakes, and alarm means for notifying a user of a time to take a particular medication or medications. The system may further comprise means for verifying medication intakes.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a diagram of image magnification in accordance with a preferred embodiment of the present invention.

FIG. 2 is a block diagram illustrating basic and specific enhancement in accordance with a preferred embodiment of the present invention.

FIG. 3 is a block diagram illustrating the system architecture of a preferred embodiment of the present invention.

FIG. 4 is a diagram illustrating an image magnification algorithm using bilinear interpolation in accordance with a preferred embodiment of the present invention.

FIG. 5 is a diagram illustrating a grid used to store all pixel values which any pixel in the interpolated image will be projected to in accordance with a preferred embodiment of the present invention.

FIG. 6 is a diagram illustrating fast perspective distortion correction in accordance with a preferred embodiment of the present invention.

FIG. 7 illustrates contrast enhancement in accordance with a preferred embodiment of the present invention.

FIG. 8 illustrates a clustering-based contrast enhancement method compared with a histogram-stretching based method.

FIG. 9 is a diagram illustrating a modified Niblack's binarization result in accordance with a preferred embodiment of the present invention where (a) is an original image, (b) is a binary image without post-processing, and (c) is a post-processed binary image.

FIG. 10 is a diagram illustrating binary image post-processing in accordance with a preferred embodiment of the present invention where (a) is the original binary image with background noise removed, (b) is the post-processed binary image after gap filling, and (c) is the post-processed image after stroke quality improvement.

FIG. 11 is a diagram illustrating a text super-resolution method with magnification factor 2 in accordance with a preferred embodiment of the present invention. The center pixel P in (a) is magnified to four pixels in (b) based on its neighborhood, which records the statistical text shape information based on training

FIG. 12 is a diagram illustrating a fast text super-resolution enhancement by making use of text shape patterns in accordance with a preferred embodiment of the present invention. The original image is zoomed 4 times in (b) and (c), where (a) is an original low resolution image, (b) is a bi-linear interpolation, and (c) is a result of a text super-resolution method in accordance with a preferred embodiment of the present invention.

FIG. 13 illustrates optical character recognition of degraded text in accordance with a preferred embodiment of the present invention.

FIG. 14 illustrates test-to-speech for audio feedback in accordance with a preferred embodiment of the present invention.

FIG. 15 illustrates an example of mobile file management in accordance with a preferred embodiment of the present invention.

FIG. 16 is a flow diagram illustrating mobile faxing in accordance with a preferred embodiment of the present invention.

FIG. 17 illustrates a mobile magnifying glass in accordance with a preferred embodiment of the present invention.

FIG. 18 is a diagram of a smart phone-based business card management system in accordance with a preferred embodiment of the present invention.

FIG. 19 is a diagram of a camera phone-based medication reminder system in accordance with a preferred embodiment of the present invention.

FIG. 20 is a diagram of a camera phone-based medication reminder system in accordance with a preferred embodiment of the present invention.

FIG. 21 is a diagram of a system architecture for a camera phone-based medication reminder system in accordance with a preferred embodiment of the present invention.

FIG. 22 illustrates adaptive thresholding methods for 1D and 2D barcode recognition in accordance with preferred embodiments of the present invention.

### DETAILED DESCRIPTION OF THE PREFERRED EMBODIMENTS

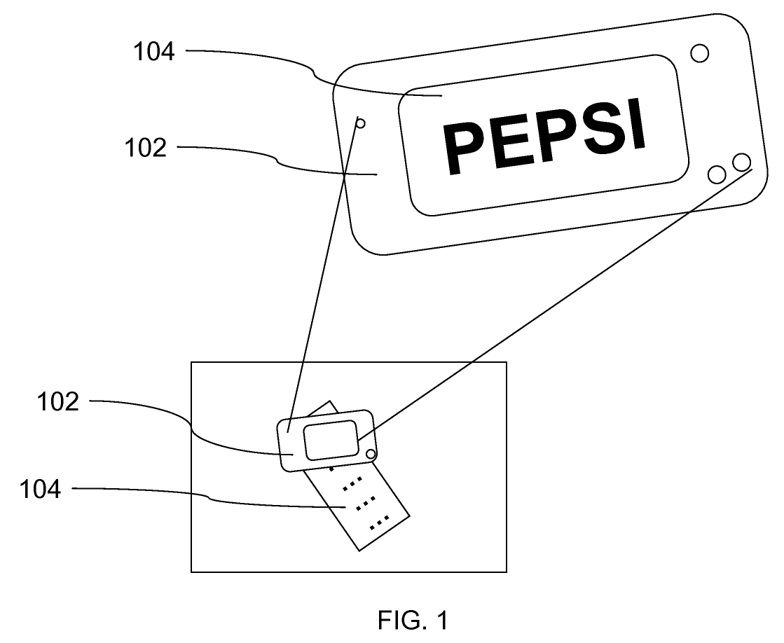

In the present invention, a software based suite uses camera enabled personal digital assistant (PDA) or cell phone hardware to provide enhanced imaging capabilities. For example, when individuals with low-vision need to read material with low contrast or fine print, they may use their mobile camera device to assist them. As shown in FIG. 1, a mobile camera device 102 is pointed at material 104 a user wishes to read. The vision enhancement tool within the mobile device captures an image of the material 104 to be read and enhances the text (e.g., through deblurring, resolution and/or contrast enhancement) to produce readable text 104. The enhancement may be accomplished according to a profile, for example, set up by a user. The enhanced text may be displayed as shown in FIG. 1 or may be converted to audio and read aloud by speakers embedded in the device.

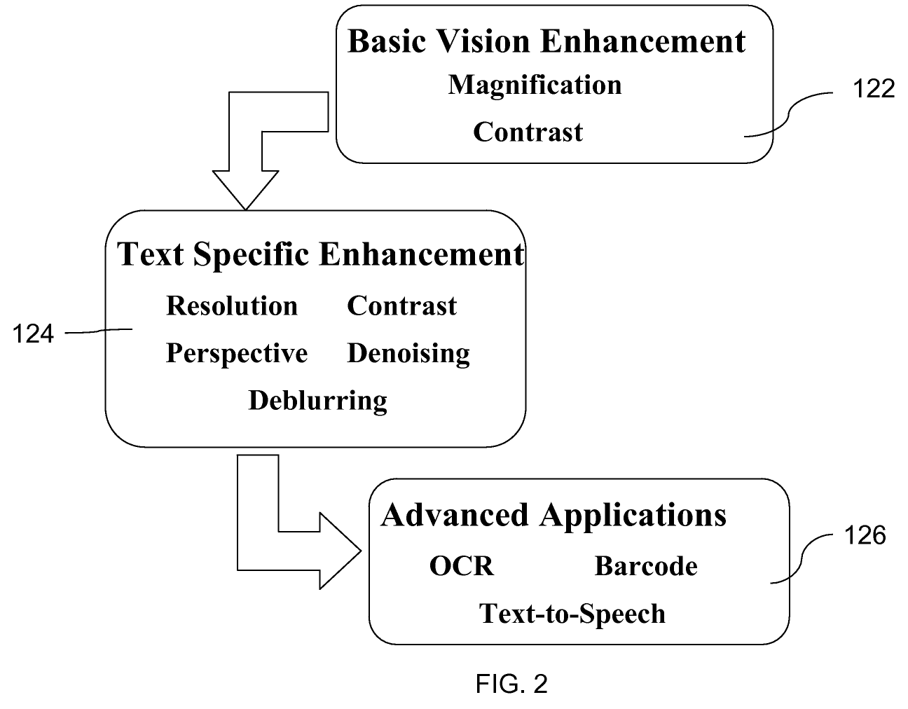

As shown in FIG. 2, the vision enhancement tool may provide basic magnification and contrast enhancement capabilities 122 for both near and far vision. Further, when text is present, the system may adapt and optimize parameters 124 such as resolution, perspective, contrast, denoising and deblurring for improved presentation by sharpening and binarization of the content. Other capabilities may include:
User-defined magnification enhancement. Digital image analysis combined with text line height estimation may scale text to a uniform size (e.g., the size may be known a priori to be of benefit to the user).
Advanced contrast enhancement. Text on some types of paper, and colored text on colored backgrounds may be difficult to read, even when magnified. Therefore, the contrast and edges may be enhanced and presented in a variety of text and background colors.
Lighting adjustment. Dark or uneven lighting conditions may make perception difficult. Therefore, adaptive enhancement may be applied to unify lighting.
Automatic deblurring. The vision enhancement tool may deblur the image so that the text can be displayed shapely.
Stabilization of images. Images may be stabilized for users with shaky hands.
Text-to-Speech (ITS). Text within images may be recognized, converted to speech using text-to-speech algorithms, and read aloud (126).

Among the many tasks where general magnification is beneficial (e.g., using appliances, reading a wrist watch, or even looking at pictures), benefits may be realized with respect to the ability to read text.

By detecting and making use of the special characteristics of text, text enhancement algorithms may be tuned to improve resolution, contrast and sharpness. For example, users may set a minimal text size displayed, and text lines may be scaled appropriately. Contrast may be customized for the user and for the content. One user with one condition may read better with a given foreground/background combination, while another may prefer the colors reversed. For non-text content, edge enhancement and histogram equalization may provide increased perception, while for text, black characters on an all white background to maximize the contrast may be more easily read. Varying and/or reversing the contrast may be provided as an individual choice.

### Functional Overview

The vision enhancement tool may be software based, and may be easily downloadable as an application to a device. The system may operate in different modes. First, the magnifier mode may provide direct video magnification and contrast enhancement of the content being imaged through the camera. To process images, a process with filters and effectively a digital zoom obtained through pixel replication may be employed. In addition, simple edge enhancement and contrast enhancement filters may be employed. To obtain higher definition or text enhancement, the user may capture a still image, which may be enhanced and displayed on the device. Since the content is magnified digitally, the screen may not be able to display the entire scene at the increased resolution. Therefore, different mechanisms for navigating through the enhanced content may be provided. For example, in order to navigate through the content, the user may move the device as if he/she was panning over the enlarged scene. The process of text enhancement may be partitioned into the tasks of image stabilization and acquisition, text detection, enhancement, and recognition. The system may be based on a dynamically reconfigurable component architecture. The component architecture may make the system easily extendable so more advanced applications can be integrated. In one embodiment, the system may be configured with only the capabilities needed for a particular enhancement task, thus optimizing resources and keeping the flexibility.

A mechanism may be provided to let the user provide the context so as to accommodate variations in lighting conditions.

### System Architecture

Component architecture may manage considerable resources on a small device. The system may operate in standalone mode providing an integrated capability.

The software modules may include the user-interface, image acquisition and display module, text detection module, and the enhancement module.

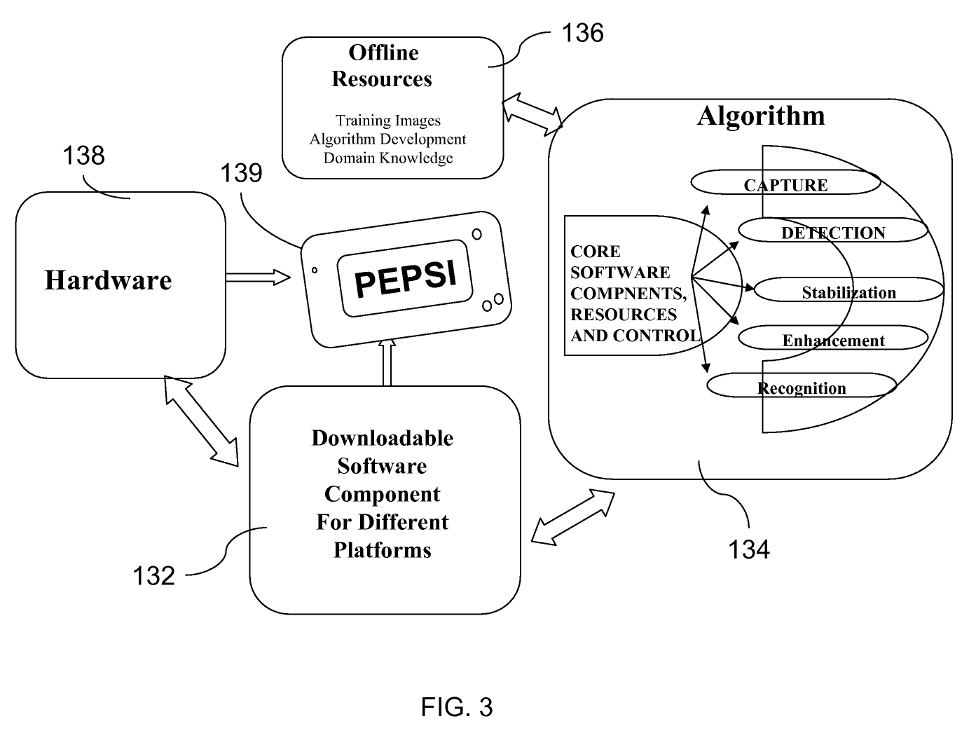

As shown in FIG. 3, the system may include a set of basic components that are managed by a core software control module 132. The core components may manage resources 134 needed by the analysis modules and swap them in from Microdrive storage on demand. The component architecture may be implemented in, for example, Symbian OS or Microsoft windows mobile. The detection and enhancement components may be written in, for example, C or C++ first, and then transplanted into different embedded platforms.

Software reusability and component management may be supported. The component architecture may provide an easy way to develop and test new algorithms 136, and may provide a basis for moving to new devices 138, where resources may be even more limited.

The cameras attached to the camera phone may be directly used as an image capturing device.

A GUI may continue to display video sequences and capture single images at the same time. When text is shown at the center of the display 139, the user may hit a button to capture the image, which may be passed to detection and recognition modules.

### Image Acquisition and Display Components

Since captured images may be at the resolution of megapixels, which may be significantly larger than the screen resolution, the user interface may allow the user to browse images within limited screen size and resolution. Image browsers may use scroll bars to cycle through image thumbnails and locate images of interest to inspect in full resolution. Another alternative is Zoomable User Interface technology, which may allow a user to watch images with gradually improved resolutions.

Additionally or alternatively, the user may navigate larger images or document images by simply moving the device. The basic concept is that after a static image of the scene is obtained and processed, to obtain an enhanced image, the camera may be retargeted to measure relative motion of the device. When the phone is panned across the scene in a given direction, the view port over the enhanced image may be moved in the same direction, giving the user the perception of scanning across the scene. The sensitivity of the motion may be controlled so that the user gets a smooth scan.

### Image Enhancement Module

Text enhancement algorithms 157, 158 may be performed prior to display. The techniques may include, for example, perspective distortion correction, image stabilization, deblurring, contrast enhancement, noise removal and resolution enhancement.

### Enhancement 1: Fast Image Magnification

The present invention implements an efficient magnification method to improve text resolutions. Generally bilinear interpolation requires floating point calculations, which make it extremely slow since there is no floating point processor in most smart phones. The real time implementation of image magnification at arbitrary scale is a fundamental requirement for lots of applications in mobile image related applications. The simple replication of pixels can satisfy the real-time requirement, the artifact, however, is very obvious.

The present invention uses a look-up table to accelerate the bi-linear interpolation to achieve real-time performance in mobile phones. In this way, the computational speed in the embedded image processing library is accelerated.

### Speedup Bi-linear Image Interpolation Algorithms.

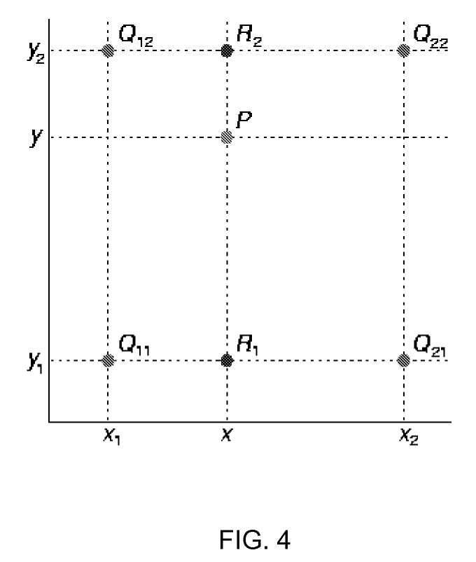

When zooming in/out of an image, a pixel in the new image is often projected back at a point with non-integer coordinates in the original image (Point P in FIG. 4). Therefore, we need to estimate the value of Point P from its four neighboring points with integer coordinates(Q₁₁(x₁,y₁) Q₁₂(x₁,y₂) Q₂₁(x₂,y₁) and Q₂₂(x₂,y₂)). To determine the pixel value at point P, first the linear interpolation in X direction is performed:

$$\begin{matrix}f ( {R}_{1} ) \approx \frac{{x}_{2} - x}{{x}_{2} - {x}_{1}} f ( {Q}_{11} ) + \frac{x - {x}_{1}}{{x}_{2} - {x}_{1}} f ( {Q}_{21} ) \\ f ( {R}_{2} ) \approx \frac{{x}_{2} - x}{{x}_{2} - {x}_{1}} f ( {Q}_{12} ) + \frac{x - {x}_{1}}{{x}_{2} - {x}_{1}} f ( {Q}_{22} ) \\ where \\ {R}_{1} = ( x , {y}_{1} ) \\ {R}_{2} = ( x , {y}_{2} )\end{matrix} \} \qquad ( 1 )$$

And then interpolation in Y direction is performed:

$$f ( P ) \approx \frac{{y}_{2} - y}{{y}_{2} - {y}_{1}} f ( {R}_{1} ) + \frac{y - {y}_{1}}{{y}_{2} - {y}_{1}} f ( {R}_{2} ) \qquad ( 2 )$$

### Substituting (1) into (2), we have

$$f ( x , y ) \approx \frac{f ( {Q}_{11} ) ( x - {x}_{2} ) ( y - {y}_{2} )}{( {x}_{1} - {x}_{2} ) ( {y}_{1} - {y}_{2} )} + \frac{f ( {Q}_{21} ) ( x - {x}_{1} ) ( y - {y}_{2} )}{( {x}_{1} - {x}_{2} ) ( {y}_{1} - {y}_{2} )} + \frac{f ( {Q}_{12} ) ( x - {x}_{2} ) ( y - {y}_{1} )}{( {x}_{1} - {x}_{2} ) ( {y}_{1} - {y}_{2} )} + \frac{f ( {Q}_{22} ) ( x - {x}_{1} ) ( y - {y}_{1} )}{( {x}_{1} - {x}_{2} ) ( {y}_{1} - {y}_{2} )} \qquad ( 3 )$$

From this formula one can estimate how many floating point multiplication and addition operations are required to finish the process. Since we know that (x₁−x₂)=−1 and (y₁−y₂)=−1, and we need to calculate f(Q₁₁)(x−x₂)(y−y₂), f(Q₂₁)(x−x₁) (y−y₂), f(Q₁₂)(x −x₂)(y−y₁), and f(Q₂₂)(x−x₁)(y−y₁) these four formulas, each of which requires two floating point subtractions and multiplications. Therefore, each pixel in the interpolated image will requires 2×4+3 floating point additions (subtractions), and 2×4 floating point multiplications. This means the interpolation of an image at VGA (640×480) resolution requires 640×480×11=3379200 floating additions, and 640×480×8=2457600 floating multiplications. As we tested on a DELL Av50 PDA (650 MHzCPU, 64 MB memory) the interpolation of an image to VGA resolution takes almost 2 minutes. The reason is, mobile devices often use software emulation to process floating point calculation, instead of specific hardware floating point processor in PC.

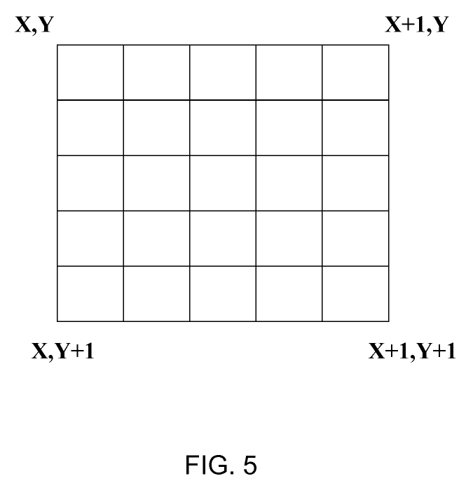

Since many applications mainly handle the text, one bit can be used to represent each pixel: black for foreground and white for background, or versa visa. This is true since clustering based contrast enhancement was performed first. Therefore, [f(Q₁₁) f(Q₁₂) f(Q₂₁) f(Q₂₂) ] has at most 16 combinations. We quantize (x−x₁) and (y−y₁) at a small step interval t, as shown in FIG. 5. Each pixel in the interpolated image will correspond to one grid point in FIG. 5. Therefore, we only need to pre-calculate the pixel value at each grid point and store it. The smaller t is, the larger the number of grid points is, and the more memory it requires to store the values. In our case we let t=0.01. The size of the look-up table which stores all the pixel values is 100×100×16=160 KB.

After pre-calculating the look-up table, the image interpolation becomes a memory-indexing process without any floating calculation. As we tested on Dell Av50 PDA, it takes only 10 milliseconds to interpolate an image at VGA resolution. This means we achieved over 200 times acceleration in PDA. The acceleration comes from: 1) The elimination of all floating point calculation, and 2) look-up table. When we move the same experimental protocol to the desktop PC, however, we only observed around 5× acceleration, since there is floating point processor in Desktop PC. The 5× acceleration is mainly achieved through the look-up table. The cost of this acceleration is 160 KB extra memory.

### Enhancement 2: Perspective Distortion Correction

Users may capture the text image from any arbitrary angle. To read the text we need to correct the perspective distortion first. The first step is to calculate the mapping between the ideal, non-perspective image and the real-captured image, which can be described as a plane-to-plane homograph matrix H. For any matrix entry (i, j), Ĥ maps homogeneous coordinate x=(i, j, 1) to its image coordinate X=Ĥx. Suppose we know n matrix entries (xᵢ, yᵢ, 1), and their corresponding image points (Xᵢ, Yᵢ, 1), where i=1, 2, . . . n. The classical way of computing Ĥ is the homogeneous estimation method: First, reshape matrix H as a vector h=(h₁₁, h₁₂, h₁₃, h₂₂, h₂₃, h₂₄, h₃₁, h₃₂, h₃₃)^{T}, and then solve for Mh=0.

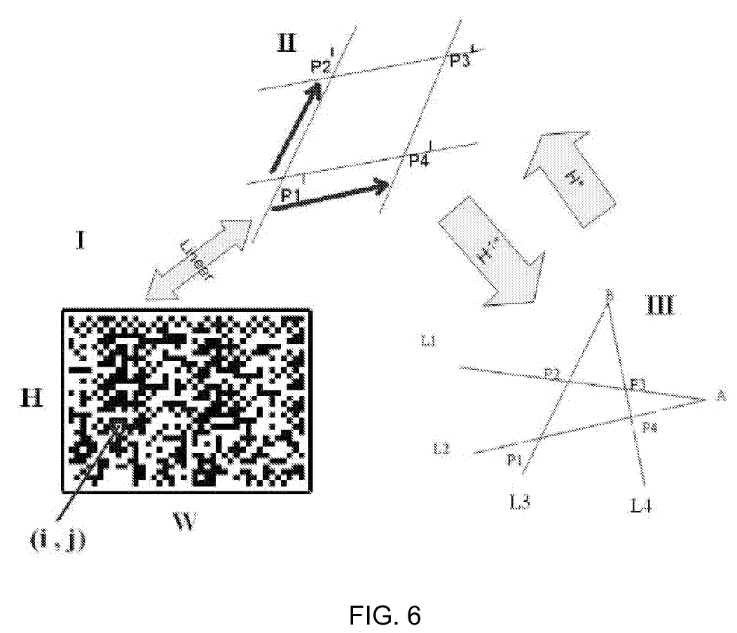

When n=4, h is the null vector of M and we have a unique solution for h (assume |h|=1 or h₃₃=1). This means what we only need the coordinates of four corners (P₁, P₂, P₃, P₄) in FIG. 6 to compute the homography Ĥ. It is very expensive, however, to solve the equation in camera phones. It usually requires LU decomposition with pivoting, which often involves significant amount of floating point calculation which is not supported by mobile phones at the hardware level. Instead, the operating systems (Symbian, Windows Mobile) provides a software emulation of IEEE-754 64 bit floating point which is much slower than integer operations. Other platforms, such as Java(J2ME), provide no floating point capabilities. This motivates us to design a simpler/faster algorithms without floating point operations, and we map out a very promising approach.

As shown in FIG. 6, an affine transformation is performed first and then a perspective transformation. Suppose we know the coordinates of four corners (P₁, P₂, P₃, P₄) in the image plane and the top and bottom boundaries of the bounding box intersect at vanishing point A. Then under homogeneous coordinates A=L₁×L₂+(P₁×P₄)×(P₂×P₃). Similarly the left and right boundaries intersect at B=L₃×L₄+(P₁×P₂)×(P₃×P₄). A and B are infinite points in the original plane. The third element of A and B under homogeneous coordinates should be 0 in the affine image. Any homography H=(H₁, H₂, H₃) that maps the perspective image back into affine image should map A and B to infinity, which implies

$$\begin{matrix}\{ \frac{{H}_{3} \cdot A = 0}{{H}_{3} \cdot B = 0} ⇒ {H}_{3} ∼ A \times B , and \\ {H}_{3} ∼ ( ( {P}_{1} \times {P}_{2} ) \times ( {P}_{2} \times {P}_{3} ) ) \times ( ( {P}_{1} \times {P}_{2} ) \times ( {P}_{3} \times {P}_{4} ) )\end{matrix} \qquad ( 1 )$$

This indicates we can calculate H₃ using only seven cross products. Any homography H with the third row H₃ calculated by (1) maps the perspective image to an affine image. The next task is to fill the first and second row of Matrix H. The reason we calculate this homography H is: Given any matrix coordinate we can quickly tell its pixel coordinate in the image. From the matrix coordinate (I) to the affine image (II), the transformation is linear and can be easily computer by transforming the base of the coordinate system. In final step we need to transform the affine image (II) to the perspective image (III) by computing H₁. We choose the first and second row of H so that it has a near inverse. We have

$$\begin{matrix}H = ( \begin{matrix}{h}_{33} & 0 & 0 \\ 0 & {h}_{33} & 0 \\ {h}_{31} & {h}_{32} & {h}_{33}\end{matrix} ) & & and & & {H}^{- 1} ∼ ( \begin{matrix}{h}_{33} & 0 & 0 \\ 0 & {h}_{33} & 0 \\ - {h}_{31} & - {h}_{32} & {h}_{33}\end{matrix} )\end{matrix} \qquad ( 2 ) , ( 3 )$$

This inverse only requires the reverse of two signs in the third row of H. In this way it simplifies the coordinate transformation with numerical stability. Normally the numerical inverse often suffers from “division by zero” when H is nearly singular. In summary, we computer the coordinate transformation in the following way:
Calculate H2 using Equation 1
Calculate H and H⁻¹ using Equation (2) and (3)
Map P₁, P₂, P₃, P₄ to affine points P′₁, P′₂, P′₃, P′₄ using H
For any entry (i, j) in the w×h matrix compute its affine coordinate

$$\frac{i}{w} {P}_{1}^{′} {P}_{4}^{′} + \frac{j}{h} {P}_{1}^{′} {P}_{2}^{′}$$

and use H⁻¹ to map this affine coordinate to the image coordinate.

### No floating point computation is required in the above procedures.

### Enhancement 3: Contrast Enhancement

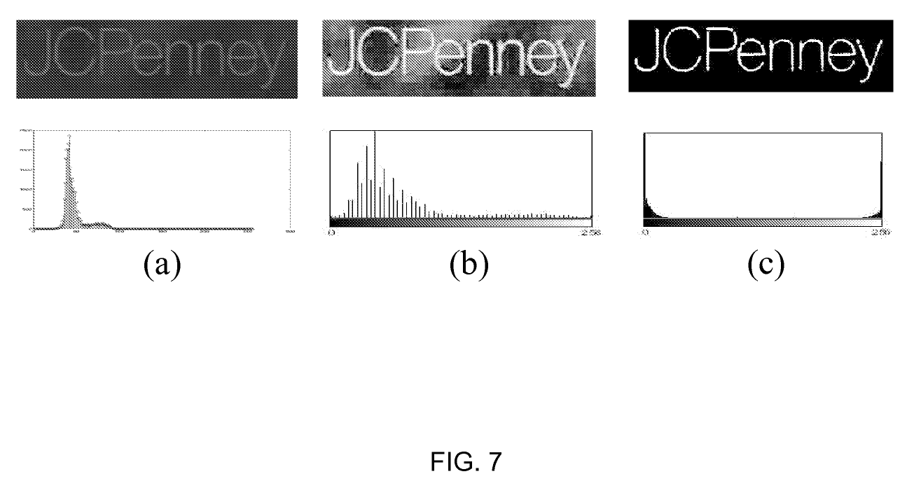

Under some adverse imaging conditions the majority of the pixel values may lie in a narrow range, potentially making them more difficult to discriminate. One technology that may make it easier to discern subtle contrasts is called contrast enhancement which may stretch the values in the range where the majority of the pixels lie. Mathematically, contrast enhancement may be described as s=T(r), where r is the original pixel value, T is the transformation, and s is the transformed value. T may be linear or non-linear, depending on the practical imaging conditions. The principle is to make light colors (or intensity) lighter and dark colors darker at the same time, so the total contrast of an image can be increased. FIG. 7 illustrates an original low-contrast image (FIG. 7(a)) and improved images using a histogram-stretching based method (FIG. 7(b)) and a cluster based contrast enhancement (FIG. 7(c)).

### Cluster Based Contrast Enhancement

The text and background pixels may form two clusters. When image contrast is high, the distance between two cluster centers may be larger. Therefore, a clustering based contrast enhancement method that uses this unique feature of text images for contrast enhancement, may be used to achieve contrast enhancement. First, the two clusters may be found, and then the contrast may be enhanced based on the two clusters.

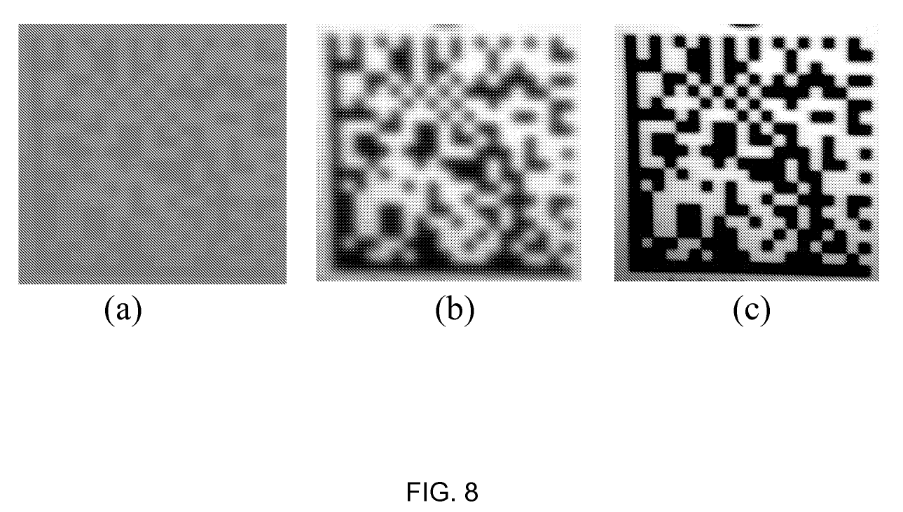

Histogram stretching may be a very common and effective approach to general contrast enhancement. However, it may not be the ideal technique when the content is pseudo binary. This is illustrated in FIG. 8. FIG. 8(a) is an original low-contrast image, and FIG. 8(b) is the contrast enhanced image after performing a histogram stretching technique. Although the contrast may be increased, some background pixel values also may be stretched, making the black cell units hard to separate from background.

The black block and background pixels form two clusters. When image contrast is high, the distance between two cluster centers is larger, and vice versa. Therefore, the two clusters may be found and used to enhance the contrast. The algorithm is described as:

1. Initialization. Choose two initial cluster centers C1(O) and C2(0) representing the black clock and background pixels, which can be random values between, for example, 0 and 255 for gray scale images. Practically the Convergence may be accelerated if C1(0) and C2(0) are selected as values between the minimum, maximum, and the mean of the image pixel values.

2. Pixel Clustering: For each pixel in text image I(ij) at iteration n, calculate the minimum distance: d(i,j)=arg min |I(i,j)−Cₖ(n)|,k=1,2. The pixels then may be allocated to the cluster with the minimum distance. In this way, the pixels may be partitioned into two clusters C1 and C2 based on this distance measure. The error at iteration n may be calculated as:

$$e ( n ) = \frac{1}{M \times N} {\sum }_{i = 0}^{M} {\sum }_{j = 0}^{N} d ( i , j )$$

where M×N is the size of the image. The iteration may stop when e(n) is smaller than a preset threshold.

3. Updating: Generate the new location of the center by averaging the pixel values in each cluster:

$$C 1 ( n ) = \frac{1}{{N}_{C 1}} \sum C 1 ( i , j ) ; \qquad C 2 ( n ) = \frac{1}{{N}_{C 2}} \sum C 2 ( i , j ) ;$$

where N_{C1} and N_{C2} are the number of pixels in C1 and C2 respectively. The iteration stops where e(n) does not decrease.

### 4. Smart Stretching

After two cluster centers are determined, one center may be put at a small value (0, for example), and another may be put at a large value (255, for example), and the histogram may be stretched based on these two centers.

FIG. 7(c) is an example of a contrast enhancement result based on the cluster based contrast enhancement approach.

### Enhancement 4: Denoising

To make the algorithm be able to applied on mobile devices, a novel binarization method is used which combines the Niblack's and block-based binarization approaches. The approach consists of the following three steps: (i) For each pixel, determine if binarization is required based on a N×N neighborhood using the block-based approach. If binarization is unnecessary, then all pixels inside this neighborhood are set to background and skipped. (ii) For each pixel requiring binarization, calculate the binarization threshold using Niblack's approach and conduct binarization. (iii) Post-process the binary image to remove ‘ghost’ objects.

A special implementation of the computation of sample mean and standard deviation significantly improves the speed of binarization. Given the neighborhood size 5×5, for a pixel at position (i, j), we compute the standard deviation of pixel values in its neighborhood and then decide if the whole block need binarization based on a predefined threshold T_{b}. If no binarization is required for this block, then we mark all pixels inside this block background and move to the next undecided pixel, which is (i, j+2) in the example. In this way, we can remove all the computation for pixels that don't need binarization. The implementation of this approach is described in details as follows.

To save the computation time, for each image, we pre-compute the accumulated sum AS and square sum ASQ as, where p(i, j) is the pixel value at position (i, j):

$$AS ( i , j ) = \{ \begin{matrix}p ( i , j ) & if i = 0 , j = 0 \\ AS ( i , j - 1 ) + p ( i , j ) & if i = 0 , j > 0 \\ AS ( i - 1 , j ) + p ( i , j ) & if i > 0 , j = 0 \\ AS ( i - 1 , j ) + AS ( i , j - 1 ) - AS ( i - 1 , j - 1 ) + p ( i , j ) & otherwise\end{matrix} \\ ASQ ( i , j ) = \{ \begin{matrix}p ( i , j ) * p ( i , j ) & if i = 0 , j = 0 \\ ASQ ( i , j - 1 ) + p ( i , j ) * p ( i , j ) & if i = 0 , j > 0 \\ ASQ ( i - 1 , j ) + p ( i , j ) * p ( i , j ) & if i > 0 , j = 0 \\ \begin{matrix}ASQ ( i - 1 , j ) + ASQ ( i , j - 1 ) - \\ ASQ ( i - 1 , j - 1 ) + p ( i , j ) * p ( i , j )\end{matrix} & otherwise\end{matrix}$$

After AS and ASQ are obtained, the sample mean m and standard deviation s in a block with left-top corner (i, j) and right-bottom corner (k, l) are computed as:

$$m = \{ \begin{matrix}AS ( k , l ) / K & if i = 0 , j = 0 \\ ( AS ( k , l ) - AS ( i , j - 1 ) ) / K & if i = 0 , j > 0 \\ ( AS ( k , l ) - AS ( i - 1 , j ) ) / K & if i > 0 , j = 0 \\ ( AS ( k , l ) - AS ( i , j - 1 ) - AS ( i - 1 , j ) + AS ( i - 1 , j - 1 ) ) / K & otherwise\end{matrix}$$

s=\sqrt{ss−m·m}, where K is the number of pixels in this block and ss is computed as

$$ss = \{ \begin{matrix}ASQ ( k , l ) / K & if i = 0 , j = 0 \\ ( ASQ ( k , l ) - ASQ ( i , j - 1 ) ) / K & if i = 0 , j > 0 \\ ( ASQ ( k , l ) - ASQ ( i - 1 , j ) ) / K & if i > 0 , j = 0 \\ ( \begin{matrix}ASQ ( k , l ) - ASQ ( i , j - 1 ) - \\ ASQ ( i - 1 , j ) + ASQ ( i - 1 , j - 1 )\end{matrix} ) / K & otherwise\end{matrix}$$

To save memory which is critical for mobile devices, the above-mentioned operations are conducted on a image strip with size N×W, where W is the image width and N is the block height. Each time, only values for the middle row pixels in this strip are computed. Once the calculation is done and results are stored, the first row data in the strip is discarded and a new row will be computed based on the previous rows and added to the end of the strip. The process continues until the whole image is finished. By this implementation, we not only saved the computation time, but also saved the intermediate memory/space usage.

### Binary Image Post-processing to Remove Ghost Object

To remove the ‘ghost’ objects generated by Niblack's binarization approach, the post-processing step used in Yanowitz and Bruckstein's method (see S. D. Yanowitz and A. M. Bruckstein, “A New Method for Image Segmentation”, Computer Vision, Graphics and Image Processing, Vol. 46, No. 1, pp. 82-95, April 1989) is selected to improve the binarization result. In this step, the average gradient value at the edge of each foreground object is calculated. Objects having an average gradient below a threshold Tₚ are labeled as misclassified and removed. The detailed procedure is described as follows:
Smooth the input image by averaging the image in a 3×3 neighborhood.
Compute the gradient magnitude image G of the smoothed image using Sobel's edge operator.
For all connected foreground object, compute the average gradient of the edge pixels that are defined to be pixels connected to the background. Remove those objects having an average edge gradient value below threshold Tₚ.

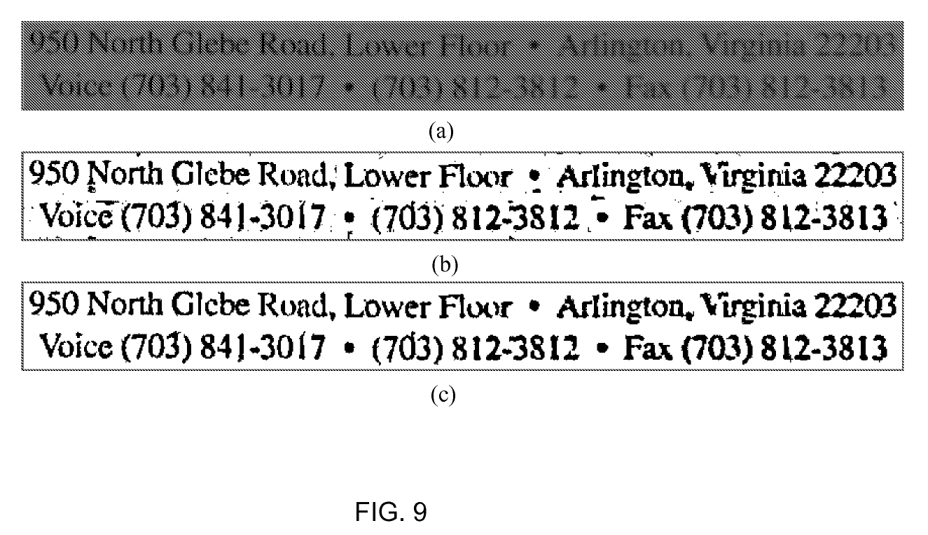

After this post-processing step, most background noise introduced by Niblack's method will be removed, However, the binarized text image is not smooth, especially at the edge of each character, there exist many small spurs which reduced the readability of text. Another observation about this approach is it might introduce broken strokes or holes in the binary image. Further post-processing steps are required to improve the text stroke quality. FIG. 9 shows an example of the binarization result. In FIG. 9, (a) is the original image; (b) is the binarized image before post-processing; and (c) is the binarized image after post-processing. We can see the image shown in FIG. 3(c) is much cleaner than the original image.

### Binary Image Post-processing to Improve Text Quality

To improve the text quality, a swell filter described in R. J. Schilling, “Fundamentals of Robotics Analysis and Control”, Prentice-Hall, Englewood Cliffs, N.J., 1990, is selected to fill the possible breaks, gaps or holes, and improve the text stroke quality. The procedure is described as follows:

### Scan the entire binary image with a sliding window having size N×N.

Suppose the central pixel at (x, y) in the sliding window is a background pixel, and the average coordinates of the foreground pixels inside this window is (xₐ, yₐ).
Then the central pixel is changed to foreground if P_{sw}>k_{sw} and |x−xₐ|<dx and |y−yₐ|<dy, where P_{sw} is the number of foreground pixels in the window, k_{sw}=0.05N², and dx=dy=0.25N.

An extension of the above conditions is applied to improve the text stroke quality. Scan the entire binary image with a sliding window having the same size N×N. Whenever the central pixel of the widow is a background pixel, count the number of foreground pixels P_{sw1} inside this window and change the central background pixel to foreground if P_{sw1}>k_{sw1}, where k_{sw1}=0.35N².

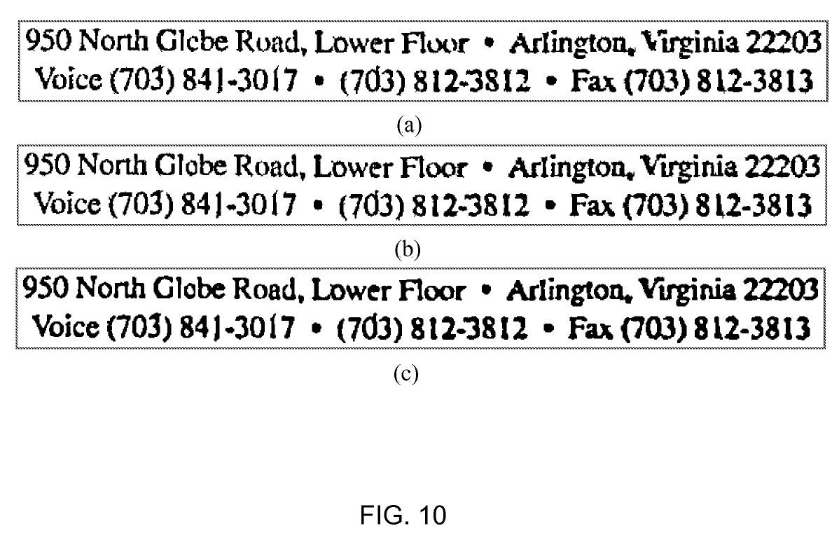

Applying this approach to real mobile-device-captured images, we obtained promising results, which are shown in FIG. 10(f), where (a) is the original binary image with background noise removed; (b) is the post-processed image after break, gap and hole filling; and (c) is the post-processed image after the text stroke quality improvement.

### Enhancement 5: Text Resolution Enhancement

The general text resolution enhancement method does not make use of specific information about text shape.

I To reduce the magnifying artifacts we need to make use of text shapes, which can provide information to maintain the high fidelity of the image even when image is magnified at large times.

The present invention uses a text super-resolution enhancement approach based on text shape training. The original method is proposed in H. Y. Kim, “Binary Operator Design by k-Nearest Neighbor Learning with Applications to Image Resolution Increasing.”, International Journal Imaging Systems and Technology, Vol. 11, pp. 331-339, 2000, but is very expensive. We will optimize the algorithm to make it be able to run on mobile devices with limited resources and computation capability.

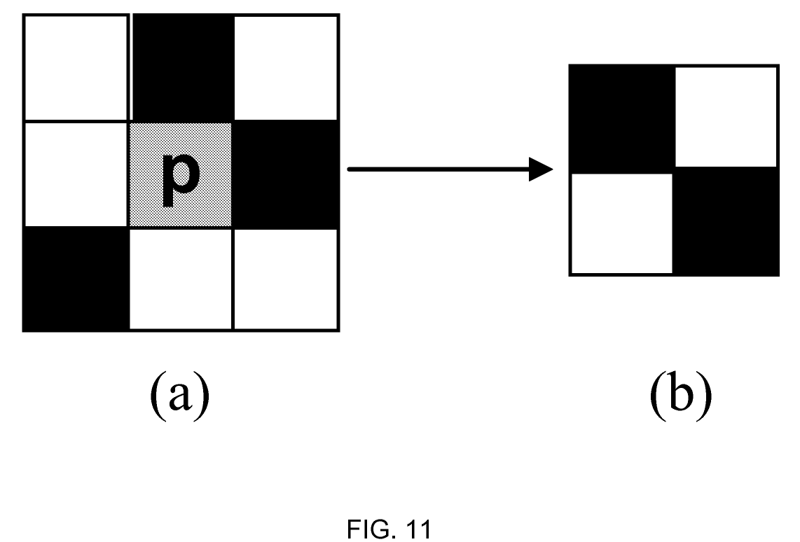

The basic idea of the method we propose to implement is as follows. Each foreground pixel in the low resolution image is represented with a pattern vector which is generated from pixel values in a N×N neighborhood of this pixel. FIG. 11(a) shows a foreground pixel with value P in the low resolution image and its neighbors in a 3×3 neighborhood. These 9 pixels will join together to generate a patter vector reflecting the central pixel. The vector that represents this pattern is [p₀p_{I}p₂p₃p₄p₅p₆p₇P₈], where pᵢ (i=0,1, . . . ,8) are values of pixels in this neighborhood (0 or 1 for binary image). The magnification of low resolution image is to convert each foreground pixel in the low resolution image to f² (f is the magnification factor) pixels in the high resolution image. FIG. 11(b) shows the foreground pixel p is converted to four pixels with values P₀, P₁, P₂ and P₃ in the high resolution image when f=2. How to convert a foreground pixel in the low resolution image is determined by: (i) The pattern that describes the foreground pixels; (ii) k−1 other patterns in the low resolution image that are similar to the pattern in (i), where the similarity between patterns is measured by the Hamming distance of two pattern vectors; and (iii) The f² pixel values in the high resolution training image corresponding with these k patterns. In the following, we use magnification factor 2 and neighborhood size 3×3 as an example to describe the detailed training phase. Assuming the training data consists of only two noiseless (ideal) images with the same text content. One image (labeled as I₁) has the low resolution 200 dpi, the other one (labeled as I₂) has the high resolution 400 dpi.

### Training Procedures:

Find all different patterns (different pattern number is 2⁹ for a 3×3 neighborhood) representing all foreground pixels in I₁. For each appeared pattern instance, find four possible corresponding pixel values in image I₂. A voting vector for each foreground pixel pattern in I₁ is computed. Assume a single pattern appears M times in I₁, the corresponding magnification pixel values in I₂ are P^{(j)}=[P₀^{(j)}P₁^{(j)}P₂^{(j)}P₃^{(j)}], where j=1, . . . ,M, then the voting vector C=[C₀ C₁ C₂ C₃] for this foreground pixel pattern in I₁, is computed as follows:

$${C}_{i} = {\sum }_{j = 1}^{M} {P}_{i}^{( j )} \qquad i = 0 , … , 3$$

For each pixel pattern in I₁, search for the k nearest patterns measured using Hamming distance, and the corresponding voting vectors C^{(l)}, l=1, . . . k. Based on all voting vectors of these patterns, the trained magnification output [P₀ P₁ P₂ P₃] for this pattern is defined as follows:

$${P}_{i} = \{ \begin{matrix}0 & if {\sum }_{l = 1}^{k} {C}_{i}^{( l )} < {C}_{h} \\ 1 & otherwise\end{matrix} \qquad \qquad i = 0 , 1 , 2 , 3$$

where Cₕ is half of the total number of pixels of the k patterns that attend the voting.

The training results are put into a look-up table which has 2⁹ rows and four columns. Four cells in each row store four output pixel values in image I₂. The binary string of the index of the table represents the pixel patterns in I₁. For example, if a foreground pixel in I₁ has the pixel pattern [0 1 0 1 1 1 0 0 1] and the four pixels it corresponds in I₂ have value [0 1 1 1]. Then the 185^{th} (010111001=185) row of the look-up table has values [0 1 1 1].

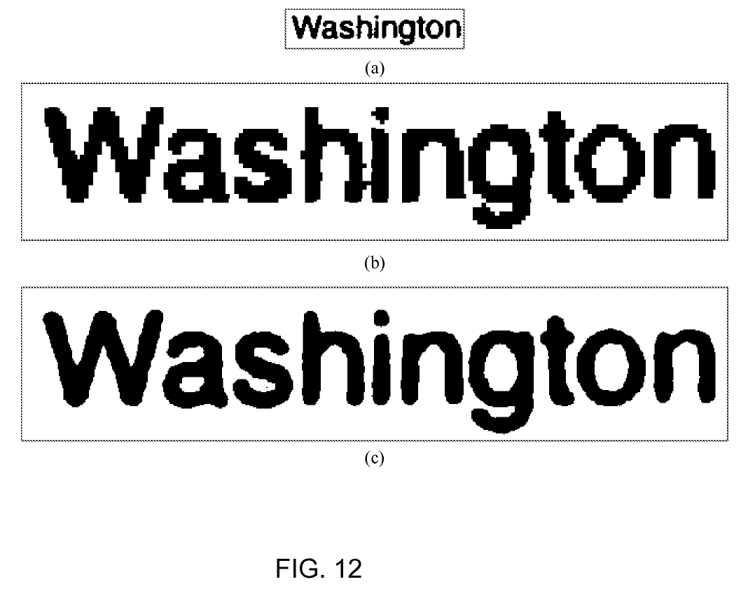

The training phase is finished once the look-up table is created. When magnifying a given binary image Iᵤ by factor 2, we only examine the foreground pixel, find the corresponding pattern and convert it to four pixels in the magnified image. For example, if a foreground pixel at position (x,y) of Iᵤ has pattern [0 1 0 1 1 1 0 0 1], then the pixels at positions (2x, 2y), (2x+1, 2y), (2x, 2y+1) and (2x+1, 2y+1) of the magnified image have values 0, 1, 1 and 1, respectively. Since the training operations can be performed offline, the magnification operation is converted to the searching of pixel pattern and looking-up in a look-up table. By this modification, text super-resolution operation can be finished in a short time. Experimental results during the writing of this proposal show that this approach can be made to run very fast on mobile devices. FIG. 12(c) shows a magnified result using this approach, which is much better than a simple magnification and magnified result using the bi-linear approach, as shown in FIG. 12(b).

### Speed and Memory Requirement Analysis:

Most super-resolution algorithms are extremely expensive and can not be embedded in the phone. For the present invention, the memory required is the size of the look-up table addressed above. It increases exponentially with respect to the neighborhood size, and linearly with the square of magnification factor f i.e. f². Given a neighborhood size N×N, and magnification factor f the look-up table size will be 2^{N×N}·f² bits, if we use one bit to represent a pixel (which is true in the binary image case). For instance, if the neighborhood size is 3×3, and the magnification factor f=2, then the look-up table only occupies 2048 (2⁹·4) bits or 512 bytes with half of bits unused. If the neighborhood size is 4×4, and the magnification factor is also 4, then the look-up table occupies 1048576 (2¹⁶·16) bits or 131072 bytes. In our initial experiments we found even with N=3, the result is significantly improved. This will leave the magnificent factor as high as possible.

The most time will be spent on off-line training. After training the magnification is just the memory access process of the look-up table.

The following applications are based on the enhancement techniques described above:

### Application 1: Mobile OCR and Text-to-Speech

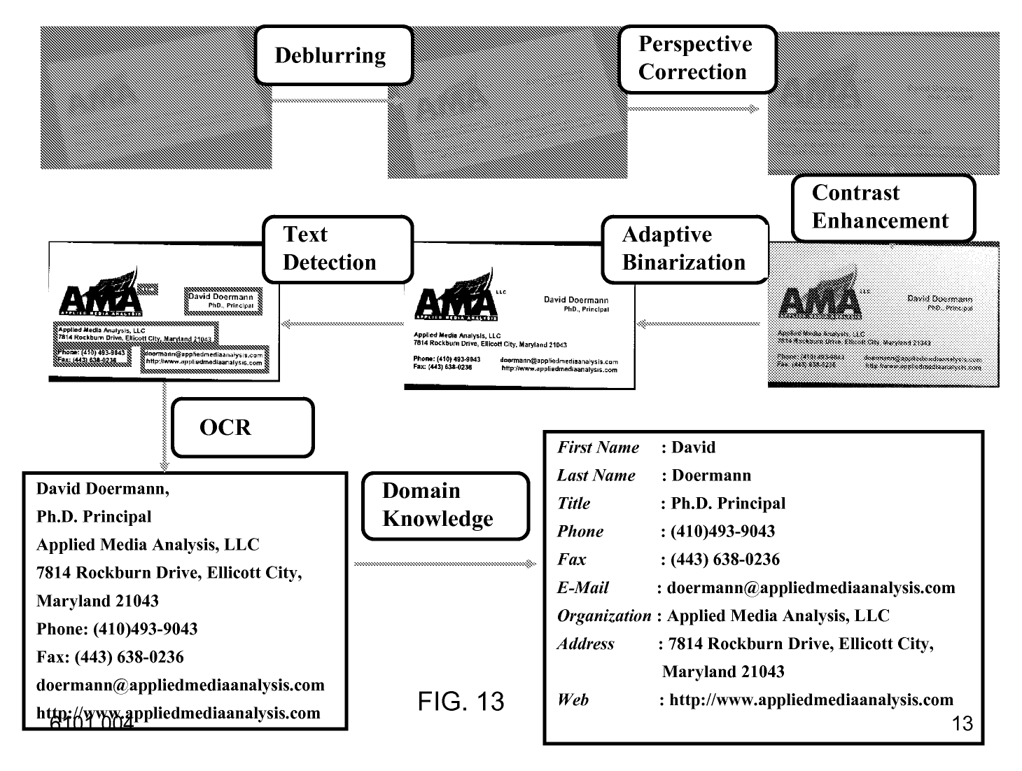

The device may also be used to read and present textual information, as illustrated in FIG. 13. For example, when an individual with low-vision needs to read a sign, he/she may take out his/her device and point it at the sign, hit a button, and the recognized text in the sign may be read out through text-to-speech (TTS).

Exemplary uses:
1. An elderly person with low vision does not know if he or she should make a turn on the next street. They take out their camera phone and aim it toward the street panel. The street name is recognized and read out from the speaker of the camera phone.
2. A visually impaired grandmother wants to purchase over the counter medication and she doesn't know if the product in her hand is what she is looking for or not. Rather then seeking assistance, she turns on the device and it reads the labels on the bottle and converts the product information to speech.
3. A grandfather receives a business card from a friend or an appointment card from a doctor's office. He wants to save the contact number into his cell phone or add the appointment to a reminder service, but finds it is really hard to input through the small keypad in the cell phone. He then captures an image of the business card; immediately text reading software converts the physical card into tagged electronic contact info, and automatically adds it to his contact list in the cell phone.

### Optical Character Recognition (OCR) from Degraded Text

### HMM Model for OCR from Degraded Text

Text captured from camera phones may be degraded even after enhancement. For example, touching and/or broken characters may be common. Once the text region is segmented, a hidden Markov model (HMM) approach may be used to handle the touching or broken characters. In this approach a statistical language model may be created in terms of bi-gram co-occurrence probabilities of symbols and models for individual characters. This method may simultaneously segment and recognize characters based on a statistical model.

In the HMM approach, each character may be represented using a discrete HMM. HMM is a generative model: at each discrete time the system may be in a particular state. In this state it throws out one of the allowed symbols. The symbol picking process may be random and may depend on the probability of each symbol in that state. After a symbol is thrown out, the system may jump to another state according to a state transition probability. The HMM parameters may be for example: symbol probability within each state, bi-gram state transition probability, and initial state probability. Model training may be performed as follows: each text line image may be broken into a left-to-right sequence of overlapping sub-images; each sub-image then may be converted into a discrete observation symbol by using a vector quantization scheme; the observation sequence and the corresponding transcription (ASCII groundtruth text) then may be used to estimate the model parameters.

The recognition process may split the text line image into a sequence of sub-images and convert the sub-image sequence into a sequence of discrete symbols. A dynamic programming algorithm may be used to segment the symbol sequence into a sequence of recognized characters.

### Knowledge-Driven OCR

To further improve OCR accuracy, knowledge in a specific domain may be used to refine the OCR result from the recognition engine. A database consisting of digitized samples of reading material for each task may be developed and used to characterize the distributions of print parameters (e.g., size, font, contrast, color, background pattern, etc.) for each task. The system parameters may be specifically selected based on these specific application domains.

### Contextual Dictionaries

The words that appear in the list of ingredients in a product may be from a very restricted vocabulary. In fact, once the generic category of a product is known, the words that may appear in the contents may be further restricted. Domain knowledge may be used to improve the recognition accuracy of the OCR subsystem. The knowledge may be represented as, for example, dictionaries and/or thesauri. Furthermore the consumer may add words that they encounter in their daily living and create their own user dictionaries.

### Query Driven Recognition

The system may allow users to spot keywords in large document repositories or in isolated documents in the field. At times, the consumer may be searching for the existence or absence of certain ingredients in a product. For example, an asthma patient might want to confirm that a bottle of wine does not contain sulfites. In such a scenario, words other than “sulfites” (and various orthographic renditions thereof) may not be important. A user-interface may be provided so the user can specify the word.

### Output and Presentation

As described above, both audio and visual feedback of recognized text may be provided to users. For visual feedback, the enhanced text may be overlayed on the display of the camera phone.

Audio feedback may be provided by a Text-To-Speech (TTS) synthesizing technology that reads text out through speakers attached to the camera phone.

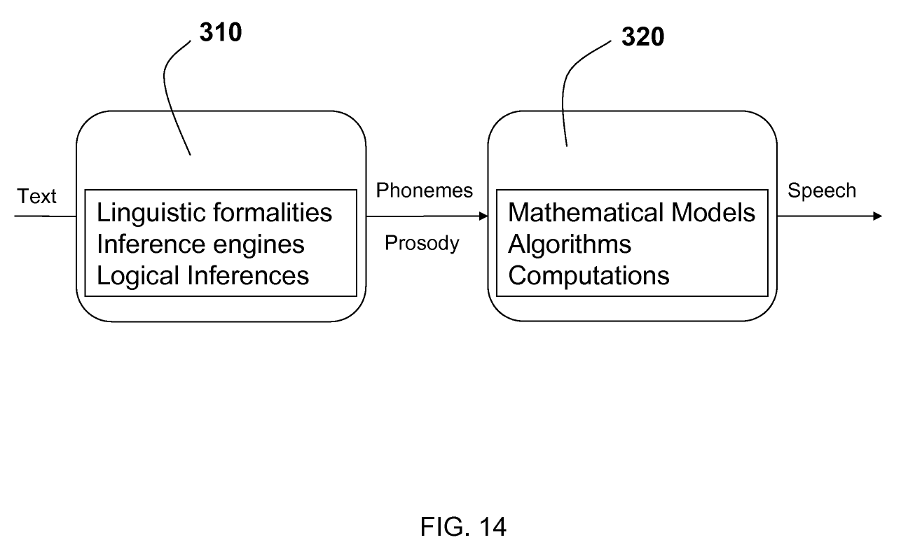

FIG. 14 is an example of a functional diagram of a TIS synthesizer. The synthesizer may include, for example, a Natural Language Processing module (NLP) 310 capable of producing a phonetic transcription of the text read, together with the desired intonation and rhythm (often termed as prosody), and a Digital Signal Processing module (DSP) 320, which may transform the symbolic information it receives into speech.

### Application 2: Using Camera Phone as a Photo Copy and Faxing Machine

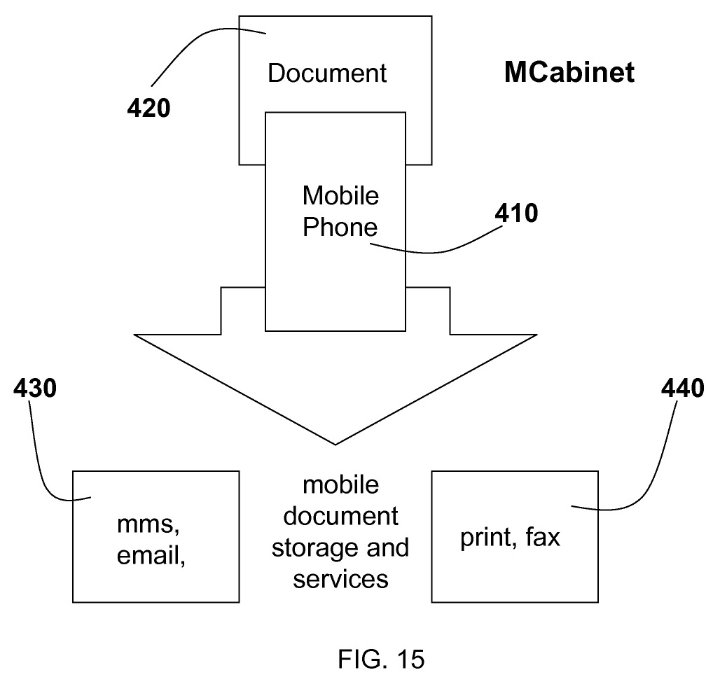

A camera equipped mobile phone having image enhancement capabilities may allow the capture and transmission of full page documents, as shown in FIG. 15. When a camera equipped mobile phone 410 is used to capture images of a document 420 to be transferred, the image quality of the captured documents may be degraded due to effects such as, for example, radial distortion, and lighting. However, such degradations may be overcome using the image enhancement techniques described above. In addition, compression and transmission methods may be used to allow a user to acquire, manipulate, store and retrieve documents through the user's mobile device. As such, a camera enabled mobile phone may be used to accomplish the equivalent of office copying, faxing, filing, e-mailing, etc. 430, 440.

Image processing capabilities may dynamically enhance images captured by a camera equipped mobile phone thereby providing copy quality suitable for reproduction, storage or faxing. In addition, captured documents may be stored automatically and mirrored on a server so as to not overwhelm the limited memory available on a mobile device. After a document has been mirrored on a server, a compact signature identifying the document may remain on the mobile device to facilitate document retrieval. Complex document search capabilities may be available on the server side. For example, documents mirrored on the server may be enhanced with OCR metadata and converted to PDF format to enable complex search capabilities. Acquired images may be faxed, emailed and/or shared with other users from the mobile telephone and/or the server. The process for selecting which documents should be mirrored on a server and when documents should be mirrored on a server may be tailored according to a user's preferences.

According to this example, users may fax or email documents acquired by camera phones anywhere and anytime. The unique document enhancement capabilities may remove excess background and provide a readable document image.

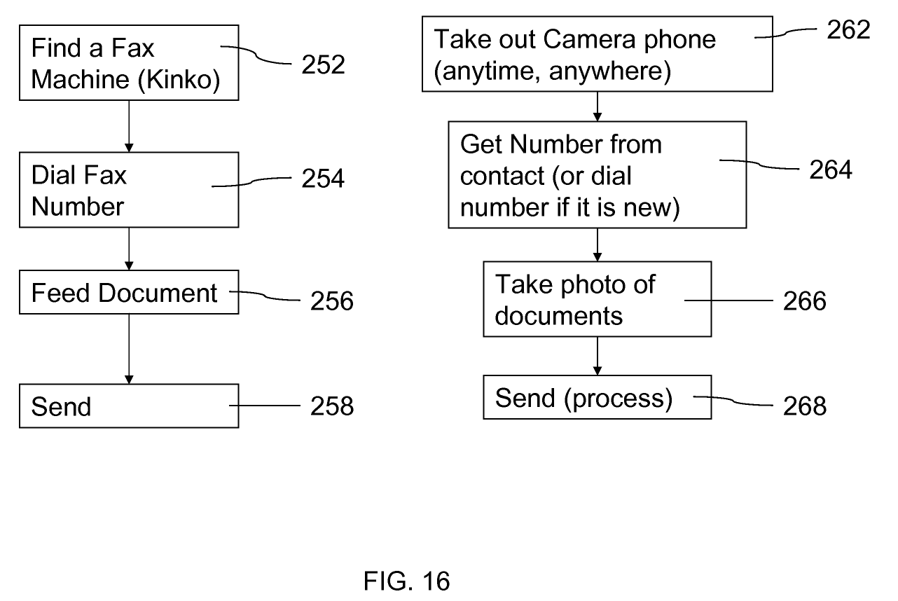

FIG. 16 shows a comparison of conventional faxing 252, 254, 256, 258 versus mobile faxing 262, 264, 266, 268. When a user desires to send a fax, the user may do so using his/her camera phone. The user can either select a fax number directly from a local or hosted contact, or the user can input the fax number using a keypad on the mobile phone (step 264). Then the user may acquire images of the documents to be faxed using the camera equipped mobile phone (step 266). The documents may be one page or multiple pages. The image processing software may process the acquired document(s) to, for example, improve image quality, compress them so they can be sent quickly, and add digital watermarking for security purposes. The enhanced document images may be sent to the fax number through, for example, telecommunication network (step 268).

### EXAMPLE 2

### Mobile Magnifying Glass

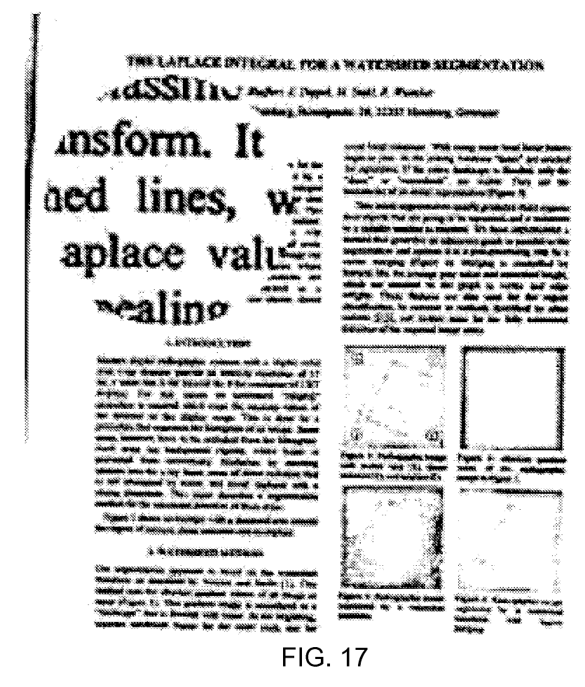

The techniques and systems disclosed herein may allow a camera equipped mobile phone to be used as a mobile magnifying glass. Two modes may be provided. (1) Continuous video mode. In this mode, the camera phone may be used just like an optical magnifying glass. For example, the user may move the camera phone around a document (or scene) he wants to read (or view), and an image is captured, enhanced and magnified, as shown in FIG. 17. The user may then use the camera phone to scan the document (or scene) and captured images will be magnified continuously just as if the user were scanning the document or scene with an optical magnifying glass. (2) In a second mode, a user may capture a still image, enhance it, and then browse and navigate the image using technology described in U.S. Provisional Application 60/748,615 entitled “Camera Motion Estimation.”

### EXAMPLE 3

### Business Card Reader

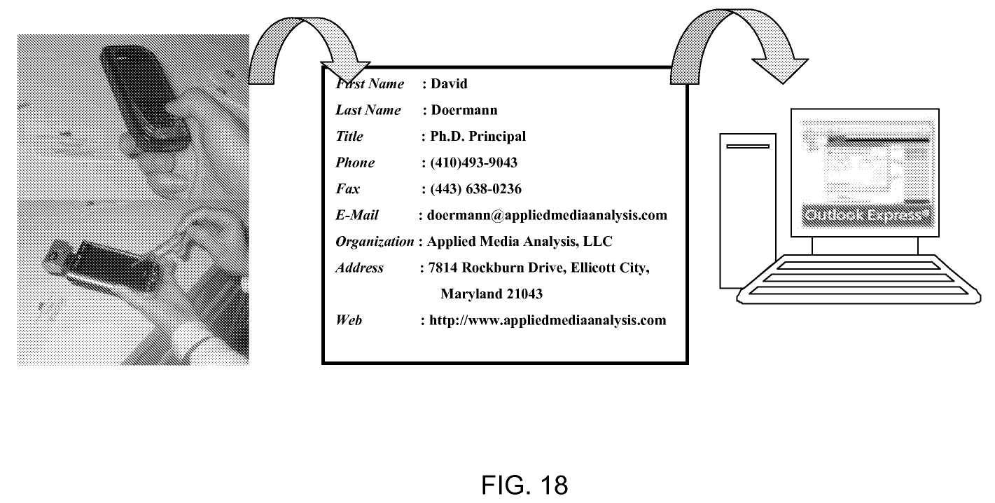

This description discloses processing techniques for enabling a resource constrained device (e.g., a mobile telephone equipped with a camera) to be used as a business card reader and contact management tool. For example, a smart-phone based business card reader enables a user to turn the user's camera-enabled mobile phone or PDA (personal Digital Assistant) into a powerful contact management tool (FIG. 18).

Smart phones are equipped with a robust business card reading capability. As a result, smart phones can be used to read business cards and manage contact information. This capability can be integrated with various devices through wireless connections. In one implementation, a user who receives a business card from a colleague at a conference may find it inconvenient to enter information through the small keypad in a mobile phone. The user captures an image of the business card with the user's mobile phone; text reading software converts the physical card into tagged electronic contact info which can later be synchronized with the information in the user's smart phone or with the contacts in other devices and or applications including, for example, Pocket PC, Outlook, PalmOS, Lotus Notes, and GoldMine, through Bluetooth or other wireless or wired connections.

Field Analysis Using: Contextual Dictionaries

The OCR will use the technology we presented in previous claims. After OCR we use contextual dictionary to refine the OCR result. Words that appear in business cards can form a very restricted lexicon. Some examples are email, com, net, CEO, etc. The domain knowledge can be used to improve the recognition accuracy and conduct the field analysis.

Text extracted from a business card may include, for example, strings of digits, sequences of words, or a combination of strings of digits and sequences of words. A digital string may indicate, for example, a telephone number, a fax number, a zip code, or a street address. A sequence of words may include one or more keywords. A keyword in a sequence of words may identify a particular field to which a portion of the extracted text should be associated. For example, a key word “email” may indicate that a line of extracted text represents an email address. Similarly, a key word “President” may indicate that a line of extracted text represents a person's title.

Extracted text may be searched for digital strings or keywords. Recognition of particular digital strings or key words may be used to associate a portion (e.g., a line) of the extracted text with a particular field. In some instances, it may not be possible to identify one or more fields by digital string or keyword. In such cases, heuristics may be used to identify the one or more fields. For example, a person's name is often found in the same block as the person's title. Typically, a title field is easily identified using a keyword search. Therefore, the person's name may be identified after the person's title has been identified.

Users may be allowed to add words that they encounter in business cards and create their own user dictionaries.

### EXAMPLE 4

### Medication Reminder

Patients may find it difficult to remember when to take which medication, and in what quantities. These problems may be addressed by a non-intrusive, compact, inexpensive, lightweight and portable solution, which may integrate multiple medication reminder services.

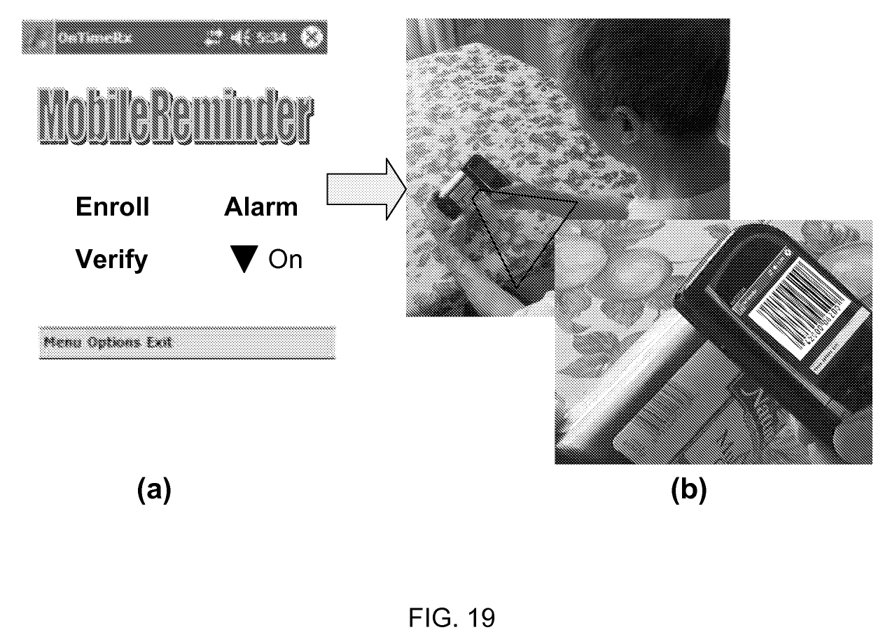

The medication reminder may include software and a camera enabled smart phone to provide enhanced medication reminding and verification capabilities (FIG. 19). Computer vision technology enables camera-enabled handheld devices to read and see. A camera phone equipped with computer vision may be used as a personal barcode scanner that allows patients to enroll and verify medication-taking by a simple barcode scanning. The approach therefore may avoid manual entry which may be extremely challenging for some patients (e.g., older patients or patients with low vision). A camera-phone based medication reminder may include the following advantages:
The camera-phone based solution may provide alarms with audio, visual and vibration.
Camera phones may be easily programmable, providing the flexibility to easily adapt to patients' specific needs
Integrated networking capabilities allow remote monitoring and configuration options via existing protocols.
The camera-phone based solution may be integrated with barcode reading capabilities to allow patients to enroll, remove and verify the medication with a simple barcode scan.
Tracking may be set up so that users know when medication was taken, or adherence can be monitored at visits to the doctors office or remotely by family through network connections (note a continuous network connection is not required for this feature, only a periodic synchronization).

Powerful image processing capabilities may be embedded into smart phones which may help improve medication adherence of patients especially if they have low vision and decreased memory. Image based barcode reading software uses cameras mounted in the smart phone to directly decode barcodes.

Some medication barcodes may include Lot/control/batch number and expiration date to protect a patient from receiving a medication that is beyond its expiration date. 1 D Barcodes are symbols consisting of horizontal lines and spaces and are widely used on consumer goods. In retail settings, barcodes may be used to link the product to price and other inventory-related information. Medication barcodes may be designed for tracking medication errors associated with drug products. 2D barcodes and other symbols also may be used to provide information relevant to a patients medicine or retail products.

A smart-phone based medication reminder may include smart-phone based barcode and symbol reading technology which may enroll and verify the medication simply through scanning.

Enrolling Medications

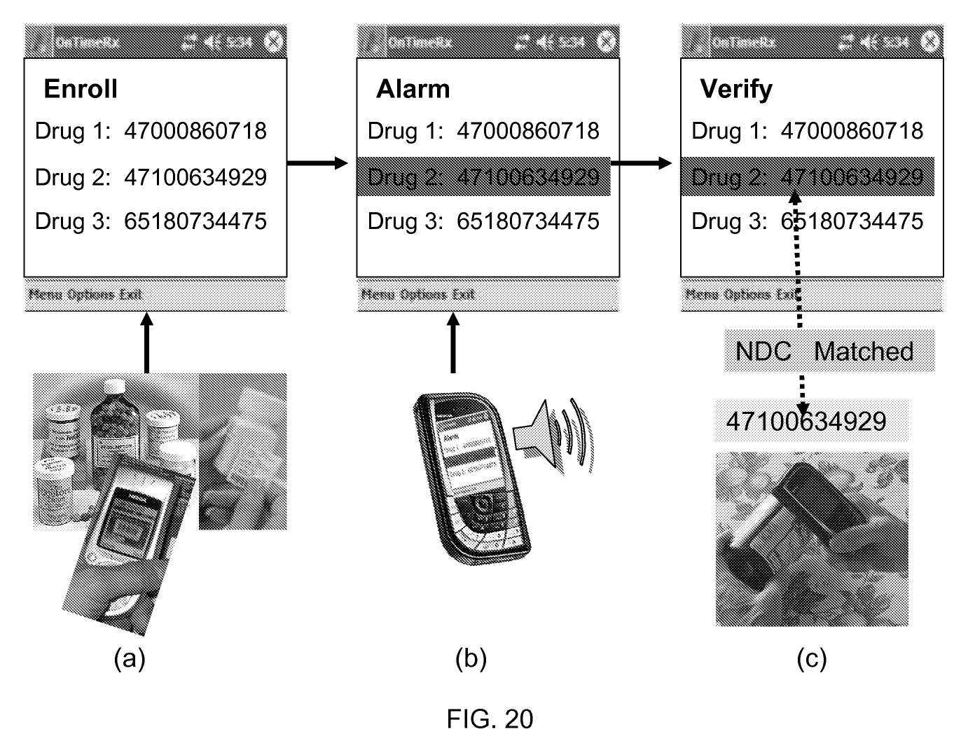

Consider this example. A 73-year-old man takes several different medications. He uses his smart phone preloaded with the medication reminder software as a medication reminding device. Some of these medications are packaged in rectangular boxes, and others in plastic cylindrical bottles. In order to enroll all of the medications into the device, he simply scans the barcode printed on the label either in a plane or in a cylinder. If he has difficulty in aiming the camera phone at the barcode, he merely moves or rotates the boxes or bottles around the camera until the smart phone beeps to indicate it detects and recognizes the barcode. He then sets the daily frequencies by pressing a numeric key (for example, number 2 to indicate to take it twice a day). This completes the enrollment process. The lot number and/or expiration date also may be decoded and saved into the system if the barcode includes them. FIG. 20(a) illustrates the enrollment process.

Reminder Alarms

Depending on the patient's needs and preferences, when it is time to take medication, the medication reminder phone may ring or present some other sound or even speech signal, vibrate, or both. If desired, this may be followed by a flashing screen, and then speech or text information to provide additional information such as the number of pills to take, as shown in FIG. 20(b).

Verification

After the reminder alarm (and perhaps the informational message), the patient may choose the medication container(s) needed. If he wants to verify that he has chosen the correct one, he may then scan the barcode, and the smart phone may compare the decoded National Drug Code (NDC) number with the one which was previously enrolled and is reminded to take, as shown in FIG. 20(c). Whether the container is correct or incorrect may be indicated by a sound, a speech message, and/or a text message.

Self-monitoring

Because adults of all ages often complain they can't recall whether or not they have taken their pills, a self-monitoring option may be included. For example, a graphic showing a day's pill schedule may be displayed. Once a pill is taken, the consumer may be able to indicate that on the graphic by pressing a key.

Functional Overview of Technology

The components of the medication reminder may be loosely partitioned into image acquisition, barcode detection, recognition, interface, alarm, Text-to-Speech (TTS), and the implementation of all of these on mobile devices. The system may be based on a dynamically reconfigurable component architecture so that it may be easily plugged into various mobile devices (cell phones, PDAs, etc.).

System Architecture

The component architecture manages a large number of resources on a small device. Physical storage for resources, memory for processing, and power consumption are all considerations. The system may operate in standalone mode providing an integrated capability. Dynamic management is also possible.

The software modules include the user-interface; medication enrollment; a removal and verification module; and a barcode detection, enhancement and recognition module.

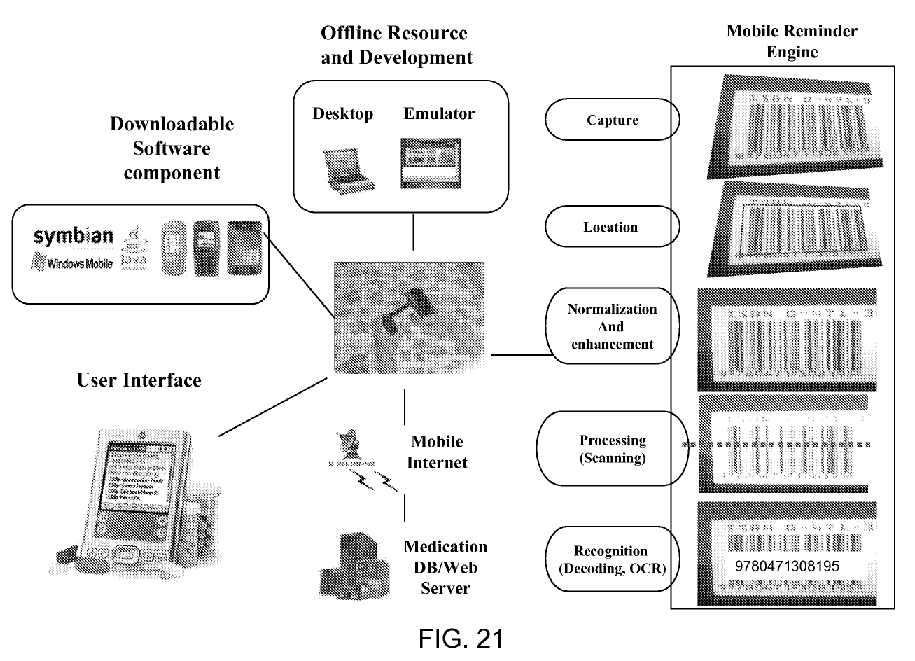

As shown in FIG. 21, the system may include a set of basic components that may be managed by a core software control module. The core components may manage resources needed by the analysis modules and may swap them in from the Microdrive storage on demand. The component architecture may be implemented, for example, in Symbian OS or Microsoft Windows Mobile. The detection and enhancement components may be written in C or C++ first, and then transplanted into different embedded platforms.

Software reusability and component management may be supported. The component architecture may provide an easy way to develop and test new algorithms, and it may provide a basis for moving to new devices, where resources may be even more limited.

Interface for the Functionalities

The interface may include, for example, the following functionalities:

Drug information enrollment: The interface may allow users to enter a New Drug record. Users may type the information through the popup keyboard in the smart phone. However, many patients may not be able to do this. Therefore, a barcode reading capability may be provided which allows users to enroll the new drug through a simple scan.

Select Frequency and Time of Doses: The interface may allow users to set the frequency of dose they want to take. For example, they may select from 1 to 6 doses per day, or select hour-based dosing alarm times. After selecting the frequency, they may be able to adjust the alarm time by, for example, using the up and down arrows.

Setting supply reminders: It may be important to maintain an adequate supply of all of medications at all times. Missing doses of certain types of drugs may be very serious, even life threatening. The interface may allow the users to input the total supply and count the actual number of pills if some doses have been taken.

Deleting Drug Items: When patients want to delete an item, they may simply scan the barcode of that drug and select “delete” from the menu in the interface.

Verification: Verification may be accomplished simply through a barcode scanning.

Customization: The interface may be customizable in terms of functionality, so that users with different physical requirements can use the system effectively, allowing for different alarms, vibrations or visual displays.

Summary: The present invention provides robust algorithms for detection and rectification of barcodes on planes and generalized cylinders subject to perspective distortions and logging features allow adherence monitoring by the user, family or medical personnel. The fact that these devices have inherent connectivity (they are networked devices) allows for further remote setup, and monitoring. A cross-platform software architecture so the software based solution can be easily embedded into smart phones with different operating systems. Further, the systems may incorporate combined visual/audio/vibration outputs for alarms.

### Scanning the Barcode

AMA has developed a technology called Mobile IBARS, which converts users' camera phones into personal data scanners. AMA is commercializing Mobile IBARS technology in the healthcare market with potential licensing deals with a commercial company providing nutrition/diet service for the customers. The principle of Mobile IBARS simulates the general optical barcode scanner by scanning the image line by line and decoding the barcode from the generated 0 and 1 sequence. The steps can be briefly described as:

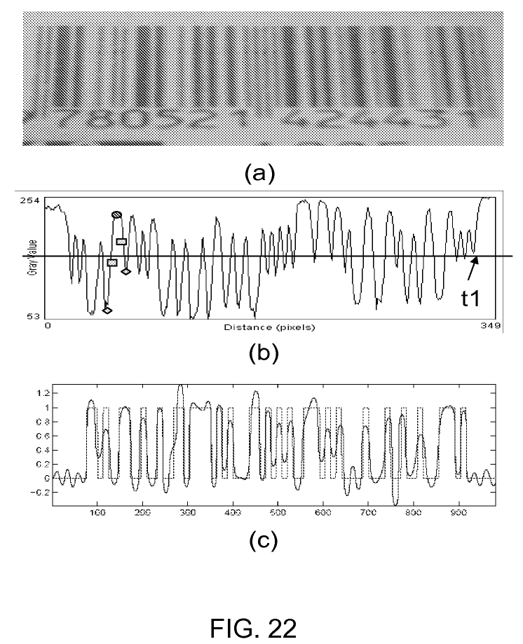

Image Capture: In this process, the barcode images are captured using the interface customized for a variety of applications (FIG. 22(a)). The user simply starts the application and points the camera at the barcode.

Scanning: The software scans the image from a starting point and gets a waveform. FIG. 22(b) shows the waveform of a scanned line.

Thresholding: Binarization converts the waveform into a rectangular series of pulses (FIG. 22(c)).

Sequence Generation: After generating the rectangular waveform, each bar (or space) can be converted to the count of 1s or 0s by nᵢ=wᵢ/w_{b}, where wᵢ is the width of the ith bar (or space), and w_{b} is the module width. The module width can be directly estimated from guard bars.

Decoding: After generating a binary sequence, the decoding is straightforward. For example, in EAN-13 each character is encoded by seven digits, and consists of two bars and two spaces. The check digit can be used to further improve the identification result.

Verification: A barcode often contains a check digit to verify if a barcode is correctly decoded. For example, the last digit of EAN-13 is a check digit which satisfies

$$( {\sum }_{i = 1}^{12} {w}_{i} {c}_{i} + {c}_{13} ) \% 10 = 0 ,$$

where % denotes the mod operation, c₁,c₂, . . . c₁₂ is the digit sequence, c₁₃ is the check digit, wᵢ=1 if i % 2=1, and wᵢ=3, if i % 2=0. If the verification passes, then the decoded character sequence is correct; otherwise, the program scans the next line until the decoding and verification pass.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for enhancing an image on a mobile device comprising the steps of:
pre-calculating a pixel value at each point on a grid and storing said pre-calculated pixel values in a lookup table;
using one bit to represent each pixel in said image;
quantizing said image at a small step interval such that each pixel in the image corresponds to one point on said grid; and
interpolating said image through a memory-indexing process.

2. A method for enhancing an image on a mobile device according to claim 1 further comprising the step of performing clustering based contrast enhancement on said image prior to said step of using one bit to represent each pixel in said image.

3. A method for enhancing an image on a mobile device, wherein coordinates of four corners (P₁, P₂, P₃ and P₄) of a bounding box in said image are known, top and bottom boundaries of said bounding box intersect at a vanishing point A and right and left boundaries of said bounding box intersect at a vanishing point B, comprising the steps of:
calculating a mapping between an ideal, non-perspective image and said image, wherein said calculated mapping comprises a plane-to-plane homograph matrix H=(H₁, H₂, H₃), wherein said calculating a mapping comprises the steps of:
reshaping matrix H as a vector h=(h₁₁, h₁₂, h₁₃, h₂₂, h₂₃, h₂₄, h₃₁, h₃₂, h₃₃)^{T};
calculating H₃ according to the equation
$$\begin{matrix}\{ \frac{{H}_{3} \cdot A = 0}{{H}_{3} \cdot B = 0} ⇒ {H}_{3} ∼ A \times B , and \\ {H}_{3} ∼ ( ( {P}_{1} \times {P}_{2} ) \times ( {P}_{2} \times {P}_{3} ) ) \times ( ( {P}_{1} \times {P}_{2} ) \times ( {P}_{3} \times {P}_{4} ) ) ,\end{matrix}$$
calculating H according to the equation
$$H = ( \begin{matrix}{h}_{33} & 0 & 0 \\ 0 & {h}_{33} & 0 \\ {h}_{31} & {h}_{32} & {h}_{33}\end{matrix} ) ,$$
calculating H⁻¹ according to the equation
$${H}^{- 1} ∼ ( \begin{matrix}{h}_{33} & 0 & 0 \\ 0 & {h}_{33} & 0 \\ - {h}_{31} & - {h}_{32} & {h}_{33}\end{matrix} ) ,$$
mapping P₁, P₂, P₃ and P₄ to affine points P′₁, P′₂, P′₃, P′₄ using homography H; and
for any matrix entry (i, j) in a w×h matrix compute its affine coordinate
$$\frac{i}{w} {P}_{1}^{′} {P}_{4}^{′} + \frac{j}{h} {P}_{1}^{′} {P}_{2}^{′}$$
and use H⁻¹ to map this affine coordinate to the image coordinate.

4. A method for enhancing an image on a mobile device comprising the steps of:
for each pixel in said image, determining if binarization is required based upon an N×N neighborhood using a block-based approach;
if binarization is not necessary, for a particular neighborhood, set all pixels in said particular neighborhood to background;
for each pixel requiring binarization, calculating a binarization threshold using Nibliack's approach and conducting binarization; and
post-processing said binary image to remove ghost objects.

5. A method for enhancing an image on a mobile device comprising the steps of:
representing each foreground pixel in said image with a pattern vector generated from pixel values in an N×N neighborhood of said foreground pixel; and
converting each foreground pixel to f² pixels in a higher resolution image where f is a magnification factor.

6. A method for enhancing an image on a mobile device according to claim 5, wherein how to convert a foreground pixel depends upon said pattern vector, k−1 other pattern vectors in said image that are similar to said pattern vector where similarity is measured by a Hamming distance of two pattern vectors, and pixels in said higher resolution image corresponding to said k pattern vectors.
